(19) United States
(12) Patent Application Publication
(10) Pub. No.: US 2009/0280691 A1
(43) Pub. Date: Nov. 12, 2009

(54) LOW PROFILE CABLE ASSEMBLY

(75) Inventors: SU-FENG LIU, Kunshan (CN); CHIN-TE LAI, Tu-Cheng (TW); BIN XU, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/436,803

(22) Filed: May 7, 2009

(30) Foreign Application Priority Data
May 7, 2008 (CN) 200820300688.5
May 7, 2008 (CN) 200820300694.0
Jul. 8, 2008 (CN) 200820301481.X

(51) Int. Cl. H01R 24/00

(52) U.S. Cl. 439/629

(57) ABSTRACT

A cable assembly (100) includes an elongated insulated housing (1) having a base portion (11) and a mating portion (12) connected to the base portion. A plurality of contacts are received in the insulated housing. An elongated printed circuit board (3) has a body portion (32) and a mounting portion (31) connected to the body portion, the body portion disposed behind the base portion and electrically connected to the contacts, and the mounting portion offsetting the insulated housing along a transversal direction. A cable (6) is connected to the mounting portion of the printed circuit board. A cover encloses the base portion of the insulated housing and the body portion of the printed circuit board.

### FIELD OF THE INVENTION

This application claims priority to prior Chinese patent applications 200820300688.5, 200820300694.0 and 200820301481.X, the disclosure of which are incorporated herein by reference.

The present invention generally relates to a cable assembly, and more particularly to a lower profile cable assembly.

### DESCRIPTION OF PRIOR ART

U.S. Pat. No. 7,318,741 issued to Wu on Jan. 15, 2008 discloses a cable assembly. The cable assembly includes an insulative housing, a number of contacts disposed in the housing, an insulator with a base and a distal portion extending upwardly from the base, a plurality of conductive wires, and a cover, the cables comprises a plurality of conductors received in the distal portion of the insulator, passing through the base and connected to a rear portion of the housing, the cover assembled on the rear portion of the housing, enclosing insulator, and has a body portion, and a receiving portion behind the body portion, the base of the insulator are received of in the body portion, and the distal portion of the insulator are received in the receiving portion, said cables extend out of the cover from a lateral side thereof.

However, a lengthwise/longitudinal dimension of the cable assembly may be a little large as accessories aforementioned of the cable assembly being arranged in the same direction.

Hence, an improved cable assembly is highly desired to overcome the aforementioned problem.

### SUMMARY OF THE INVENTION

Accordingly, an object of the present invention is to provide a low profile cable assembly.

In order to achieve the object set forth, a cable assembly in accordance with the present invention comprises an elongated insulated housing having a base portion and a mating portion connected to the base portion. A plurality of contacts are received in the insulated housing. An elongated printed circuit board has a body portion and a mounting portion connected to the body portion, the body portion disposed behind the base portion and electrically connected to the contacts, and the mounting portion laterally extending beyond the insulated housing. A cable is connected to the mounting portion of the printed circuit board. and a cover encloses the base portion of the insulated housing and the body portion of the printed circuit board.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of a cable assembly of a first embodiment in accordance with the present invention;

FIG. 2 is an exploded, perspective view of the cable assembly of FIG. 1;

FIG. 3 is similar to FIG. 2, but viewed from another aspect;

FIG. 4 is a partially assembled view of the cable assembly shown in FIG. 2;

FIG. 5 is an assembled, perspective view of a cable assembly of a second embodiment in accordance with the present invention;

FIG. 6 is an exploded, perspective view of the cable assembly shown in FIG. 5;

FIG. 7 is similar to FIG. 6, but viewed from another aspect;

FIG. 8 is a partially assembled view of the cable assembly shown in FIG. 6;

FIG. 9 is an assembled, perspective view of a cable assembly of a third embodiment in accordance with the present invention;

FIG. 10 is an exploded, perspective view of the cable assembly shown in FIG. 9;

FIG. 11 is similar to FIG. 10, but viewed from another aspect;

FIG. 12 is a partially assembled view of the cable assembly shown in FIG. 10.

### DETAILED DESCRIPTION OF PREFERRED EMBODIMENTS

Reference will now be made in detail to the preferred embodiment of the present invention.

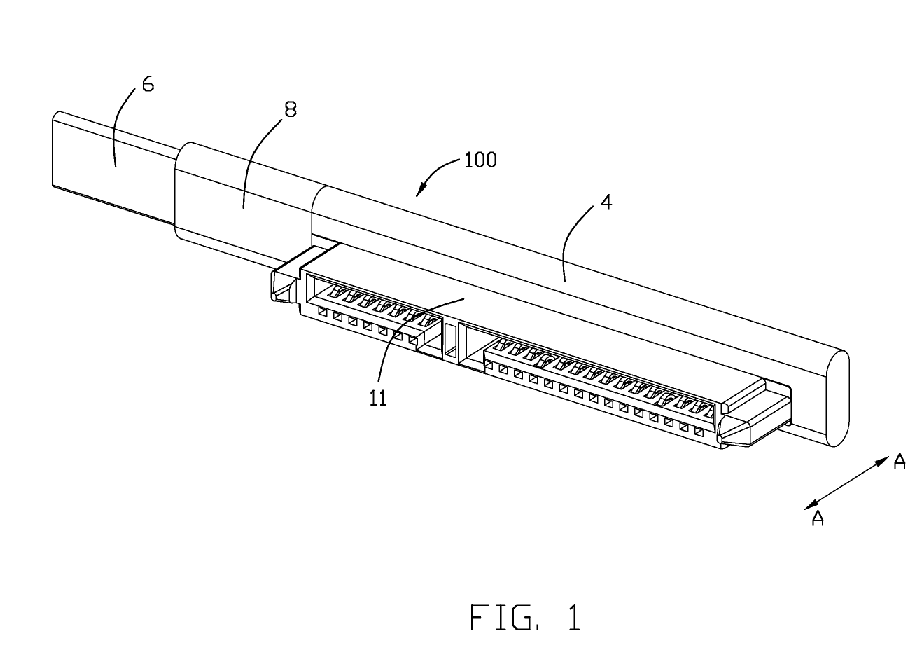

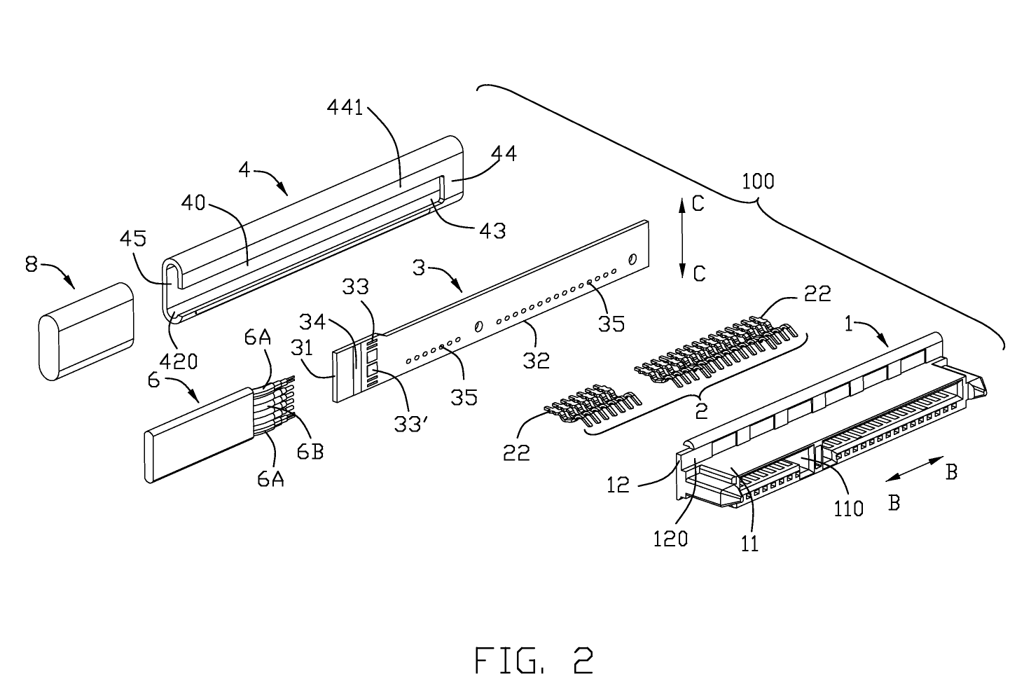

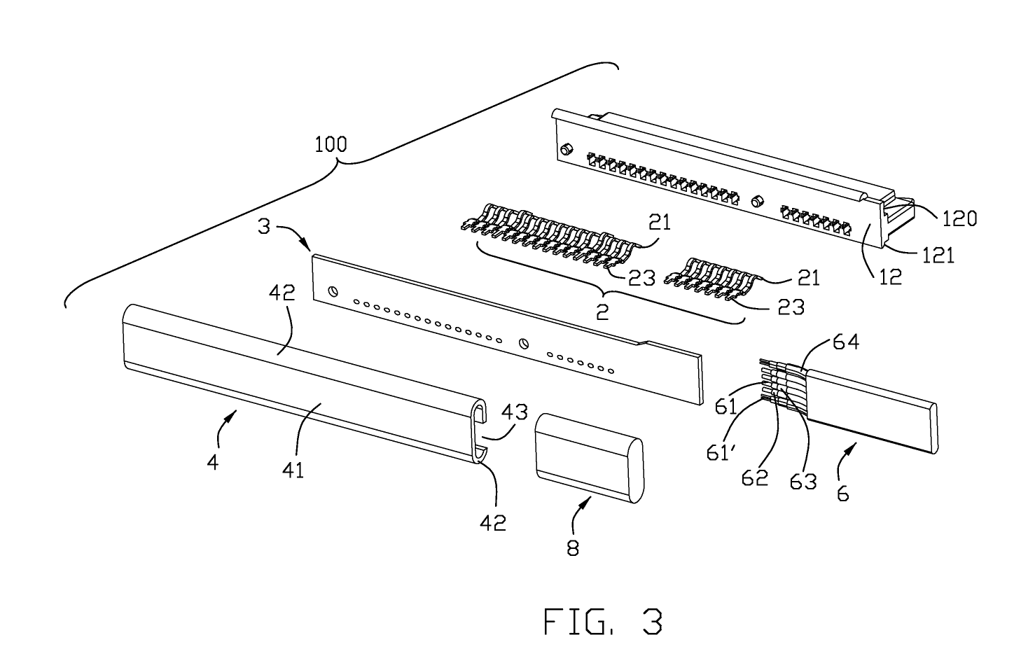

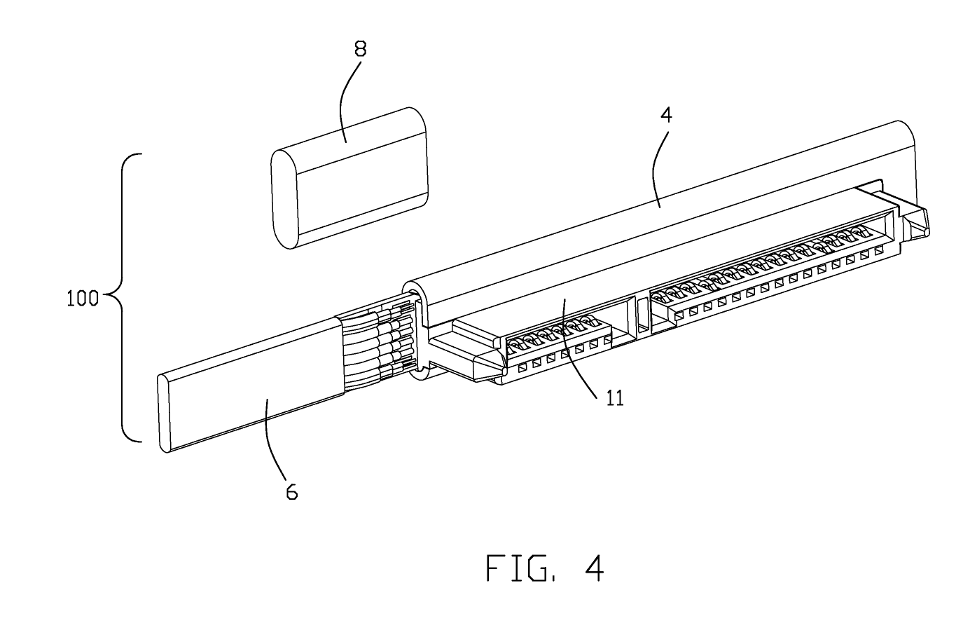

Referring to FIGS. 1-4, a cable assembly 100 of a first embodiment in accordance with the present invention comprises an insulated housing 1, a plurality of contacts 2 received in the insulated housing 1, a printed circuit board (PCB) 3, a cover 4, a cable 6 and an enclosing member 8.

The insulated housing 1 includes a base portion 12 and a mating portion 11 extending forwardly from a front side of the base portion 12. The mating portion 11 has two ports 110 arranged in juxtaposed manner. The base portion 12 is broader than the mating portion along a vertical direction C-C. The base portion 12 has a first flange 120 and a second flange 121 which are respectively located above and below the mating portion 11. The first flange 120 is longer than the second flange 120 in the vertical direction C-C.

The contacts 2 are separated into two distinct rows along a transversal direction B-B and mounted to the insulated housing 1 along a mating direction A-A. Each of the contacts 2 has a contacting portion 21, a tail portion 23 and a retention portion 22 interconnecting the contacting portion 21 and the tail portion 23.

The PCB 3 has an elongated body portion 32 and a mounting portion 31 connected to the body portion 32. A plurality of conductive holes 35 are defined in a lower section of the body portion 32. A number of conductive pads 33, 33′ and 34 are attached to the mounting portion 31. The conductive pads 33, 33′ are arranged in a row in the vertical direction C-C, while the conductive pad 34 is arranged in other row spaced apart the conductive pads 33, 33′ along the transversal direction B-B.

The cover 4 includes a back wall 41, a front wall 44, a pair of top and bottom walls 42 joining with the back and front walls 41, 44 to enclose a receiving space 40 therebetween. A transversal opening 43 is defined in a lower segment of the front wall 44 to form a L-shaped blocking portion 441. The blocking portion 441 is connected to the top and bottom walls 42. An outlet 45 is arranged lateral side of the cover 4 and communicates with the receiving space 40. The bottom wall 42 forms substantially U-shaped slot 420, while the top wall 42 forms an inverted U-shaped slot 420.

The cable 6 includes two signal wires 6A and four power wires 6B disposed between the two signal wires 6A. Each of the power wires 6B has an inner conductor 61, and inner insulator 62 enclosing the inner conductor 61, a metallic braiding 63 shielding the inner insulator 62, and a jacket 64 enclosing the metallic braiding 63. Each of the signal wires 6A is similar to the each power wires 6B, excepted that there are two inner conductors 61′ within the each signal wires 6A insulated from each other.

When assembling, the contacts 2 are inserted into contacts passages of the insulated housing 1, with contacting portions 21 extending into ports 110, the tail portions 23 disposed behind a back side of the base portion 12. Then tail portions 23 are inserted into the conductive holes 35 of the PCB 3 and soldered therein. The cover 4 is assembled to the base portion 12, with the first flange 120 and the second flange 121 sliding along B-B direction and accommodated in the slots 420 of the top and bottom walls 42, the mating portion 11 projected outward via the opening 43, the body portion 32 of the PCB 3 enclosed in the cover 4, and the mounting portion 31 of the PCB 3 disposed outwardly of the cover 4. The inner conductors 61, 61′ are soldered to the conductive pads 33, 33′, and the metallic braiding 63 are soldered to the conductive pads 34 of the mounting portion 31. The enclosing member 8 is over-molded onto the mounting portion 31, the conductive pads 33, 33′ and 34 and the cable 6 adjacent to the mounting portion 31. The first flange 120 is further sandwiched between the blocking portion 441 and the back wall 41. Glue or other adhesive materials may be applied to the first and second flange portions 120, 121 to make the cover 4 and the insulated housing 1 securely combined together.

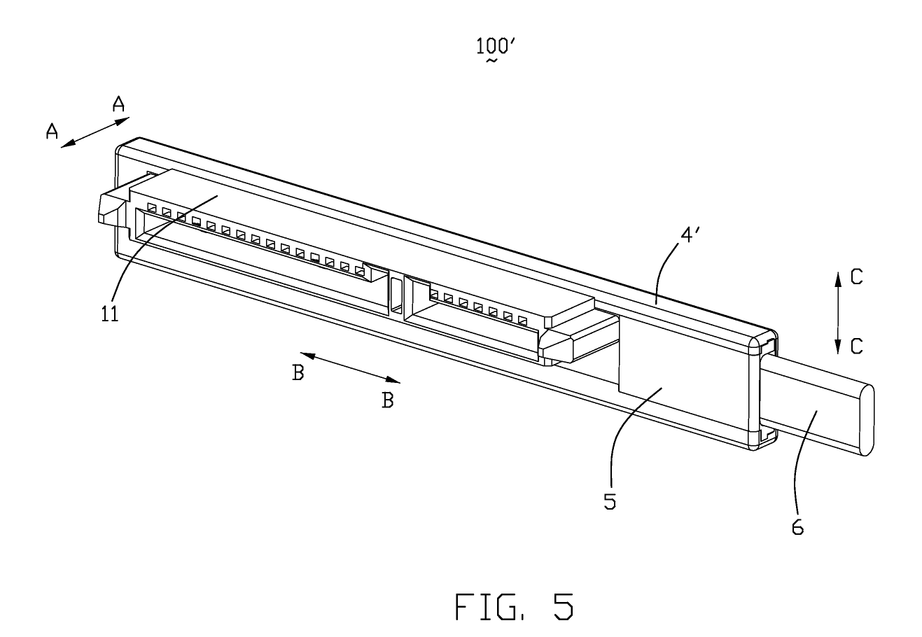

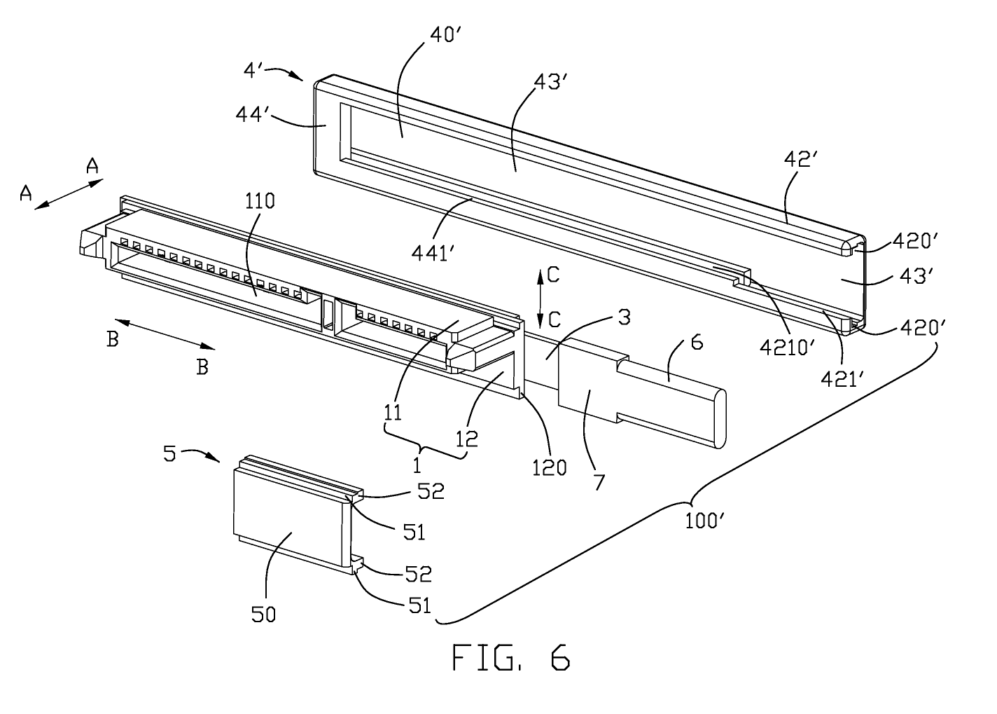

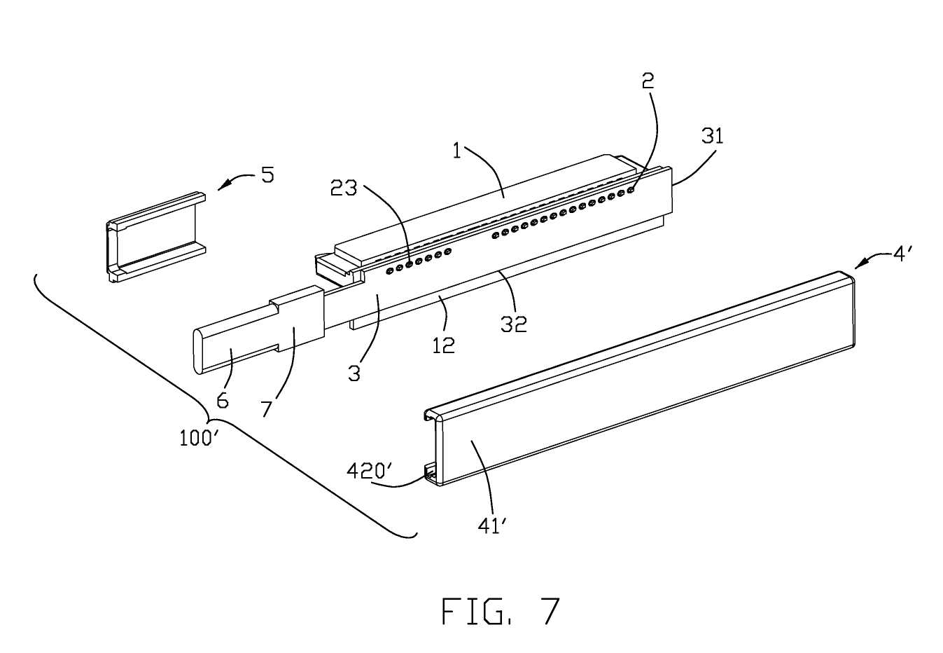

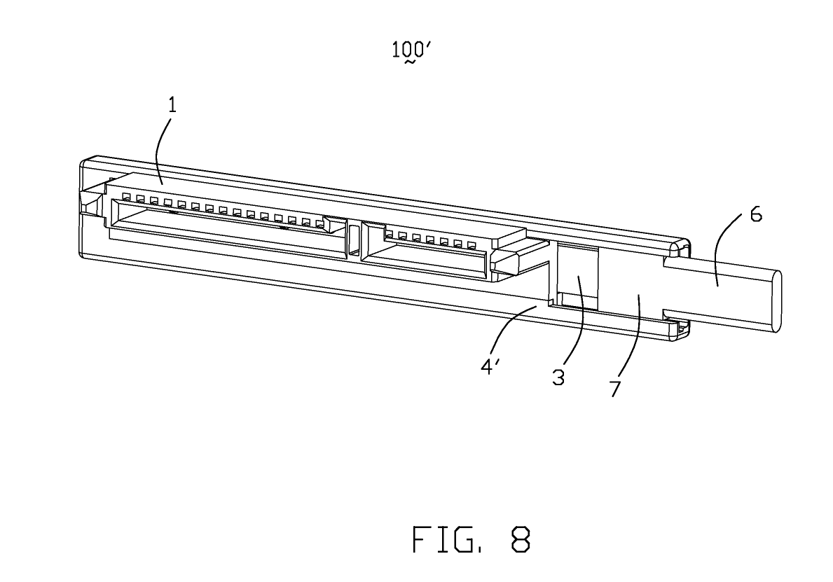

Referring to FIGS. 5-8, a cable assembly 100′ of a second embodiment in accordance with the present invention comprises an insulated housing 1, a plurality of contacts 2 received in the insulated housing 1, a PCB 3, a cover 4′, an auxiliary cover 5, a cable 6 and an enclosing member 7.

The cover 4′ includes a back wall 41′, a front wall 44′, a pair of top and bottom walls 42′ joining with the back and front walls 41′, 44′ to enclose a receiving space 40′ therebetween. A transversal opening 43′ is defined in an upper segment of the front wall 44 and in communication to the receiving space 40′, with a L-shaped stub 441′ left to connecting the top and bottom walls 42′. A partial of right portion of the elongated stub 441′ is removed to form a cutout 421′. A pair of first notches 420′ are respectively defined in the top and bottom walls 42′, and a second notch 4210 is defined in a longer side of the stub 441′ and in communication with the first notch 420′ in the bottom wall 42′.

The auxiliary cover 5 includes a vertical wall 50, a top and bottom wall 52 connected to upper and lower sections of the vertical wall 50 to form a substantially U-shape configuration. Two ribs 51 are respectively formed on a top and a bottom surface of the top and bottom wall 52.

Other elements, such as the insulated housing 1, the contacts 2 and the PCB 3 and the cable 6 are similar to those corresponding elements of the first embodiment, and detailed description is omitted hereby.

When assembling, after the cable 6 has been soldered to the mounting portion 31 of the PCB 3, the enclosing member 7 is over-molded onto the mounting portion 31, the conductive pads 33, 33′ and 34 and the cable 6 adjacent to the mounting portion 31. Then the cover 4′ is assembled to the base portion 12 of the insulated housing 1, with the first and second flanges 120, 121 sliding in the first notches 420′ and the second notch 4210′ along B-B direction, the mating portion 11 projected outward via the opening 43′, the body portion 32 of the PCB 3 enclosed in the cover 4′, and the enclosing member 7 is disposed around the cutout 421′. The auxiliary cover 5 is assembled to the cover 4′, with the ribs 51 received in the first notches 420′, and the enclosing member 7 held by the cover 4′ and the auxiliary cover 5.

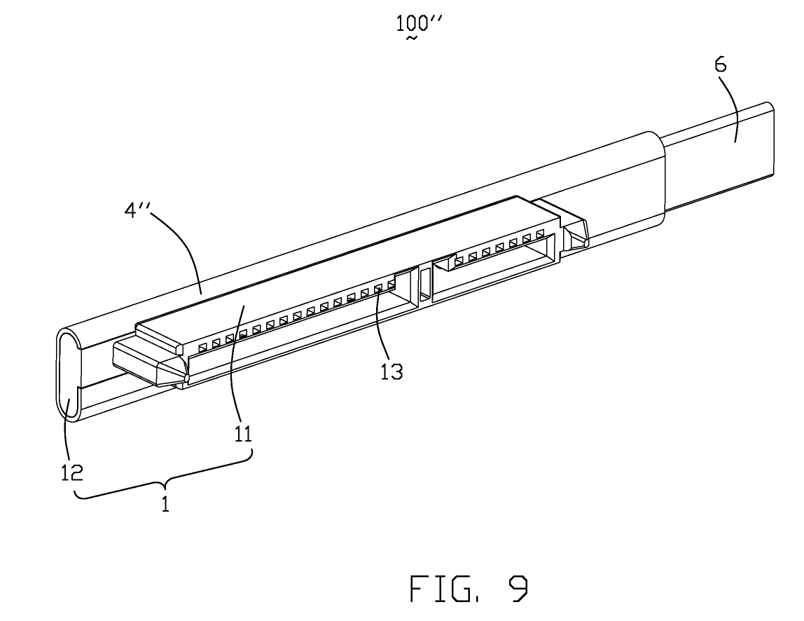

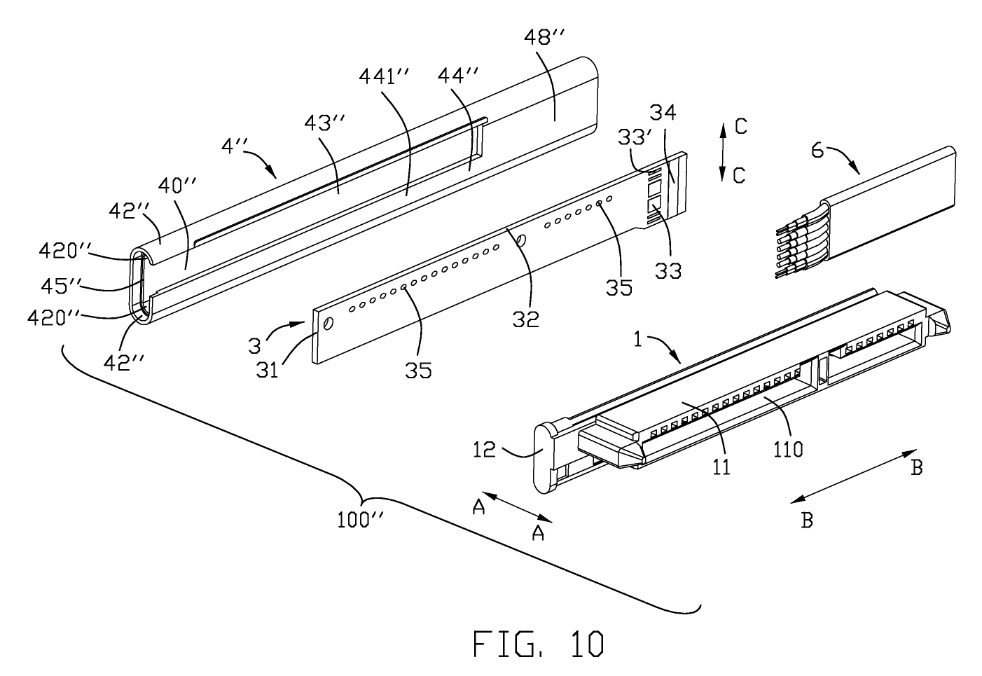

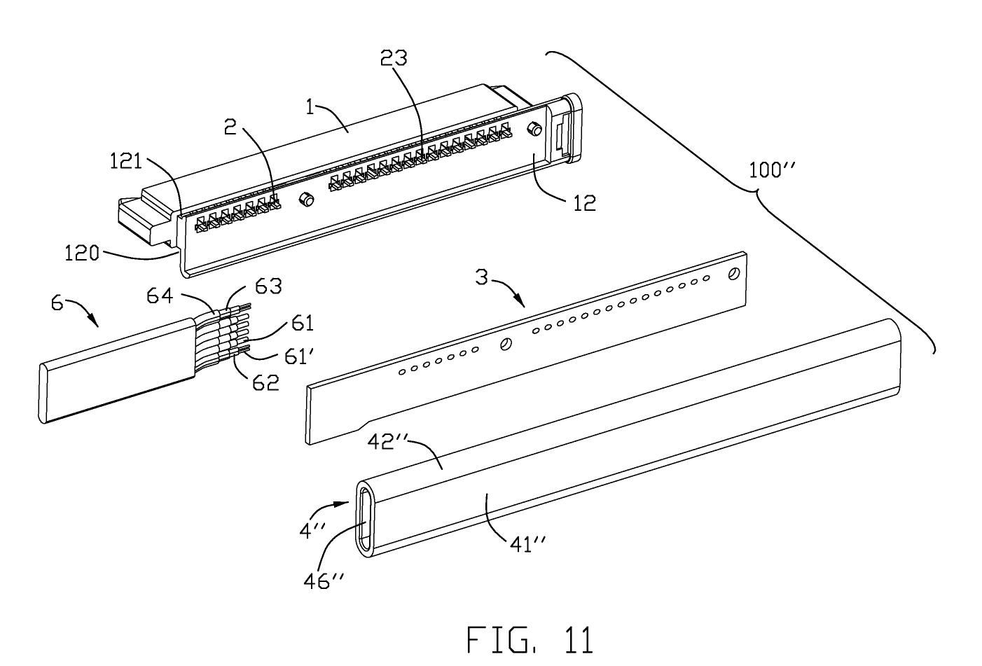

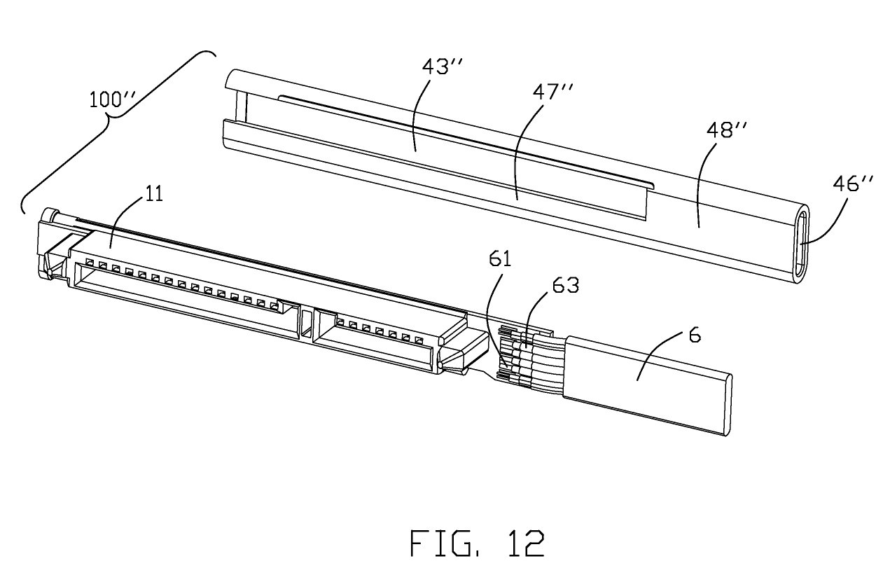

Referring to FIGS. 9-12, a cable assembly 100″ of a third embodiment in accordance with the present invention comprises an insulated housing 1, a plurality of contacts 2 received in the insulated housing 1, a printed circuit board (PCB) 3, a cover 4″, a cable 6 and an enclosing member 7.

The cover 4″ includes a back wall 41″, a front wall 44″, a pair of top and bottom walls 42″ joining with the back and front walls 41″, 44″ to enclose a receiving space 40″ therebetween. A transversal opening 43″ is defined in an upper segment of the front wall 44″ and in communication to the receiving space 40″, with an elongated rib/stub 441″ left to connect the bottom wall 42″. An outlet 45″ is arranged in a left side of the cover 4″ and communicates with the receiving space 40″. The bottom wall 42″ forms substantially U-shaped slot 420′, while the top wall 42 forms an inverted U-shaped slot 420″. A boot portion 48″ is arranged at right side of the cover 4″ and joined to the back wall 41″, the pair of top and bottom walls 42″ and the rib 441″. The boot portion 48″ further has an exiting hole 46″ arranged in a right side thereof.

Other elements, such as the insulated housing 1, the contacts 2 and the PCB 3 and the cable 6 are similar to those corresponding elements of the first embodiment, and detailed description is omitted hereby.

When assembling, after the cable 6 has been soldered to the mounting portion 31 of the PCB 3, the cover 4″ is assembled to the base portion 12, with the first flange 120 and the second flange 121 sliding in the slot 420″ along B-B direction and accommodated therein, the mating portion 11 projected outward via the opening 43″, the body portion 32 of the PCB 3 enclosed in the cover 4″. The mounting portion 31, the conductive pads 33, 33′ and 34 and the cable 6 adjacent to the mounting portion 31 are received in the boot portion 48″, and the cable 6 extending outward through exiting hole 46″.

As the mounting portion 31 of the PCB 3 offsets (or laterally extending beyond) the insulated housing 1 along the transversal direction B-B, rather than disposed behind the insulated housing 1, thus, a dimension of the cable assemblies 100, 100′ and 100″ along the mating direction A-A decreases.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly, comprising:
an elongated insulated housing having a base portion and a mating portion connected to the base portion;
a plurality of contacts received in the insulated housing;
an elongated printed circuit board having a body portion and a mounting portion connected to the body portion, the body portion disposed behind the base portion and electrically connected to the contacts, and the mounting portion laterally extending beyond the insulated housing;
a cable terminated to the mounting portion of the printed circuit board; and
a cover enclosing the base portion of the insulated housing and the body portion of the printed circuit board.

2. The cable assembly as recited in claim 1, wherein the cover includes a back wall, a front wall, and a top and bottom walls connected to the back and front walls to form a receiving space receiving the base portion and the body portion.

3. The cable assembly as recited in claim 2, wherein a transversal opening is defined in the front wall of the cover, with the mating portion of the insulated housing projected outward via the transversal opening.

4. The cable assembly as recited in claim 2, wherein the top and bottom walls form two slots, the base portion has two flanges respectively accommodated in the two slots.

5. The cable assembly as recited in claim 1, wherein the mounting portion of the printed circuit board is disposed outside of the cover.

6. The cable assembly as recited in claim 5, wherein a number of conductive pads are arranged on the mounting portion and wires of the cable are soldered to the conductive pads.

7. The cable assembly as recited in claim 6, wherein an enclosing member is over-molded onto the mounting portion to enclose the conductive pads and partial of wires adjacent to the mounting portion.

8. The cable assembly as recited in claim 6, wherein a boot portion is integrated with the cover, the mounting portion of the printed circuit board together with the conductive pads and the wires adjacent thereto is received in the boot portion.

9. The cable assembly as recited in claim 6, wherein the conductive pads are divided into two rows along the transversal direction.

10. The cable assembly as recited in claim 9, wherein inner conductors and metallic braidings of the wires are respectively soldered to the two rows conductive pads.

11. The cable assembly as recited in claim 1, wherein the mounting portion of the printed circuit board is arranged at a lateral side of the cover, and the cable has a number of wires connected to conductive pads on the mounting portion.

12. The cable assembly as recited in claim 11, wherein an auxiliary cover engages with the cover to enclose the mounting portion therebetween.

13. The cable assembly as recited in claim 12, wherein the auxiliary cover is assembled to the cover along the transversal direction.

14. The cable assembly as recited in claim 12, wherein the auxiliary cover is accommodated in the cover.

15. A cable connector assembly comprising:
an insulative housing defining a mating port;
a plurality of contacts disposed in the housing with front contacting sections exposed in the mating port and rear tail sections opposite to the front contacting sections;
a printed circuit board located on a rear portion of the housing and electrically and mechanically connected to the tail sections, respectively;
a cover defining a longitudinal receiving cavity with a lateral opening at a longitudinal end for allowing insertion of the rear portion and the associated printed circuit board into the receiving cavity, and a front opening at a front face for allowing forward extension of the mating port;
a plurality of wires mechanically and electrically connected to a mounting portion of the printed circuit board, which is located on a lateral side of the printed circuit board; and
an enclosing member discrete from the cover while protectively shielding the mounting portion of the printed circuit board and joints between the wires and the printed circuit board.

16. The cable connector assembly as claimed in claim 15, wherein said enclosing member is side by side arranged with the cover.

17. The cable connector assembly as claimed in claim 15, wherein said enclosing member is partially enclosed in an extension of the cover.
